(19) United States
(12) Patent Application Publication
(10) Pub. No.: US 2008/0075491 A1
(43) Pub. Date: Mar. 27, 2008

(54) Image forming apparatus

(75) Inventor: Kozo TAO, Osaka (JP)

Correspondence Address: DILWORTH & BARRESE, LLP, 333 EARLE OVINGTON BLVD., SUITE 702, UNIONDALE, NY, 11553, US

(73) Assignee: Kyocera Mita Corporation, Osaka (JP)

(21) Appl. No.: 11/903,707

(22) Filed: Sep. 24, 2007

(30) Foreign Application Priority Data
Sep. 25, 2006 (JP) 2006-258350

(51) Int. Cl. G03G 15/00

(52) U.S. Cl. 399/45

(57) ABSTRACT

An image forming apparatus is provided that selects a paper feeding stage forcibly continued through an operating section when a paper error occurs (step S11). Here, when a user selects the paper feeding stage forcibly continued (Yes), the image forming apparatus sets “FORCED CONTINUATION SCREEN” (step S12), in order to suspend a printing operation without starting, even if the paper feeding stage is replenished with paper and the paper size is changed from this time on. When the user finally confirms the forced continuation (step S13=Yes), the image forming apparatus feeds paper from the paper feeding stage selected by the user to perform a printing operation. This causes the image forming apparatus to perform a recovery operation sufficiently reflecting a user's intention when a paper error occurs.

This application is based on and claims the benefit of priority from Japanese Patent Application No. 2006-258350, filed on 25 Sep. 2006, the content of which is incorporated herein by reference.

### BACKGROUND OF THE INVENTION

1. Field of the Invention

The present invention relates to an image forming apparatus that can transfer an image using a plurality of types of paper.

2. Related Art

In conventional technologies, some image forming apparatuses of this type have been interrupted with paper errors during printing jobs, in which case the printing jobs are paused to run subsequent printing jobs. In the conventional technologies, the image forming apparatus judges that paper errors occur when paper designated for the printing jobs has not been set or cannot be set in the designated paper feeding cassettes, in which case the printing jobs are interrupted. Alternatively, in the conventional technologies, if there are subsequent printing jobs, then these printing jobs are previously executed. Therefore, the overall printing efficiency of the image forming apparatuses are not easily reduced.

Furthermore, in the conventional technologies, when the causes of the paper errors are removed by replenishment with paper and replacement of designated paper feeding cassettes, for example, the previous printing jobs that have been interrupted are immediately resumed. In this respect, it is considered to be an improvement in printing efficiency.

Ways to cope with a case in which the paper errors occur in the image forming apparatuses are not restricted to the replenishment with paper and the replacement of paper feeding cassettes designated by the printing jobs, as listed in the conventional technologies. Suppose a case where a paper error occurs because a paper feeding cassette runs out of the size of paper designated for a job by a user, for example. In this case, the user may replenish the paper feeding cassette with paper of the same size to resume the job. However, the user can have the option of forcibly continuing the job by changing the previously designated paper size to another paper size.

In the conventional technologies, if the paper feeding cassettes are replenished with paper, however, the jobs are immediately resumed irrespective of the user's intentions at that point in time. Therefore, operations reflecting the user's intentions cannot be performed. In the conventional technologies, the image forming apparatuses lack convenience as machines because they independently operate, irrespective of the user's intentions as they aim for printing efficiency.

An objective of the present invention is to provide an image forming apparatus that can operate with the user's intention sufficiently reflected thereon in dealing with a paper error.

### SUMMARY OF THE INVENTION

An image forming apparatus according to the present invention stops forming an image, and enters an error state if it runs out of a designated type of paper. When an instruction for forced continuation is issued on the basis of the user's intention in this state, the image forming apparatus according to the present invention solves the abovementioned problem by executing the forced continuation irrespective of whether or not it is replenished with the paper of the designated type.

When a paper error occurs because a designated paper accommodating section runs out of paper, for example, the paper error is expected to be eliminated if the paper accommodating section is replenished with paper. Under normal circumstances (in the conventional technologies), a printing operation (image formation) is initiated after the paper accommodating section is replenished with paper. In the present invention, when the user's intention is to force continuation, the instruction for forced continuation is carried out prior to the immediate initiation of printing, even if the paper accommodating section is replenished with paper, which gives the user's intention priority over the initiation of a printing operation.

In addition thereto, in the image forming apparatus, a paper error may occur when a different type of paper is accommodated in the designated paper accommodating section. In this case, the paper error is expected to be eliminated when the paper within the designated paper accommodating section is replaced with paper of a desired type under normal circumstances (in the conventional technologies). In the present invention, when the instruction for forced continuation is issued, however, the instruction for forced continuation is carried out prior to starting a printing operation, even if the type of paper is changed, which gives the user's intention priority over the initiation of a printing operation.

Furthermore, the image forming apparatus according to the present invention can ultimately determine whether or not forced continuation is to be executed on the basis of a user's operation. In this case, even when the image forming apparatus is replenished with paper before determining that forced continuation should be executed, it suspended a printing operation without starting. In the present invention, when the user instructs the image forming apparatus to determine that forced continuation is to be executed in a suspended state, the printing operation based on the forced continuation is initiated by stopping the suspension.

In the abovementioned case, when the user remains undecided as to whether or not forced continuation should be executed, the suspended state is continued indefinitely. Furthermore, the user may, in some cases, cancel the instruction for the forced continuation at a later time, even though he or she has issued the instruction for forced continuation once. In the present invention, when a predetermined time period has elapsed in a state in which the user determines that forced continuation should not be executed or a state in which the user does not determine that forced continuation should be executed, the instruction for forced continuation is cancelled.

In this case, the forced continuation is not executed. If the image forming apparatus is in a suspended state irrespective of replenishment with paper and a change in paper type, for example, the suspended state is released. Thereafter, the printing operation is resumed as usual, which prevents the working efficiency from being reduced.

In the image forming apparatus according to the present invention, when the user expresses an intention of forced continuation, the image forming apparatus can enter the suspended state without resuming the printing of another event, and will only continue printing with the intention of forced continuation assigned priority. Therefore, the image forming apparatus according to the present invention can perform an operation sufficiently reflecting the user's intention, which is significantly convenient for the user.

Furthermore, the image forming apparatus according to the present invention can cope as in a normal case, even in a case in which the user expresses an intention of forced continuation once, but does not make a final determination of this intention. Therefore, the working efficiency can be increased as heretofore.

### BRIEF DESCRIPTION OF THE DRAWINGS

FIG. 1 is a schematic view of an image forming apparatus according to an embodiment;

FIG. 2 is a front sectional view for explaining the internal configuration of a postprocessor;

FIG. 3 is a flow chart (1/2) showing the procedure for a program executed by an image formation control section;

FIG. 4 is a flow chart (2/2) showing the procedure for a program executed by an image formation control section; and

FIG. 5 is a successive chart showing an example of an operation screen displayed while a paper error is occurring.

### DETAILED DESCRIPTION OF THE PREFERRED EMBODIMENT

An embodiment in which the present invention is applied to an image forming apparatus such as a copying machine is described.

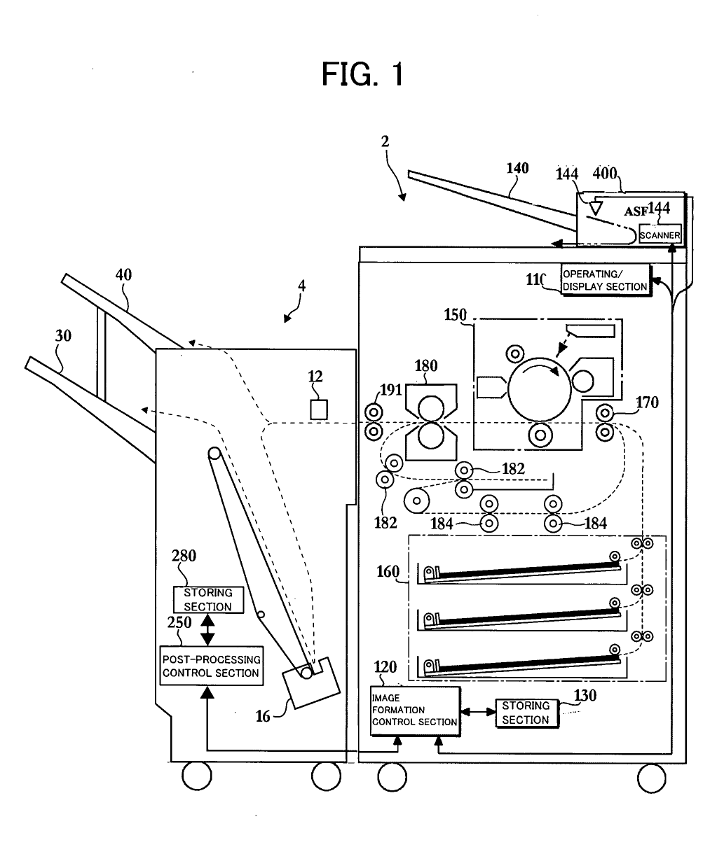

FIG. 1 is a schematic view showing the configuration of an image forming apparatus 2 according to an embodiment. A postprocessor 4 is connected to the image forming apparatus 2 adjacent to a paper discharge direction thereof. First, the respective basic configurations and functions of the image forming apparatus 2 and the postprocessor 4 are described.

As shown in FIG. 1, the image forming apparatus 2 and the postprocessor 4 are respectively equipped with an image formation control section 120 and a post-processing control section 250. The control sections 120 and 250 are respectively composed of electronic circuits including central processing units (CPUs), for example, and contained in the image forming apparatus 2 and the postprocessor 4 with the electronic circuits formed on circuit boards. Furthermore, storing sections 130 and 280 are connected to the control sections 120 and 250, respectively. Each of the storing sections 130 and 280 has storage (ROM, RAM), large capacity storage (hard disk), or the like.

In the image forming apparatus 2, data set by operating an operating/display section 110 is stored in the storing section 130 through the image formation control section 120. Examples of the settings include paper size, paper type, paper feeding direction, document density, frame erasure, binding margin, and 4-in-1 aggregate processing. Image processing is performed according to each setting. The time period required for the image forming apparatus 2 to perform image processing depends on the contents of the settings. The storing section 130 coupled to the image formation control section 120 stores an application program for a complex machine that performs multi-thread processing.

In image processing involving copying of a document, for example, when a user performs an operation of placing a document or documents on a tray 140 in an auto sheet feeder 400, and presses a start button (not shown) in the operating/display section 110, the following processing is performed in response to the operation. First, when a paper sensor 143 contained in the auto sheet feeder 400 detects document paper, the documents are fed and discharged one at a time by the auto sheet feeder 400, during which a document image is scanned by a scanner 144. Image data read at this time is stored in job units in the storing section 130 through the image formation control section 120.

The image formation control section 120 subjects the image data to preprocessing for reasons such as noise reduction of the image, then performs image processing corresponding to each type of setting, and feeds the data to a print engine 150 for each page. This causes an electrostatic latent image to be formed on a surface of a photosensitive drum in the print engine 150 to be developed by toner.

On the other hand, in the image forming apparatus 2, paper removed from a paper feeding section 160 is fed into a registration roller 170, where the paper is stopped momentarily. When the photosensitive drum in the print engine 150 reaches a predetermined rotational angle, the paper is conveyed again by the registration roller 170 at this timing. This causes a toner image to be transferred onto the paper. The paper is heated and pressed through a fuser 180. This causes the toner image to be fixed onto paper. The paper on which the toner image has been transferred serves as transfer paper. The transfer paper is discharged after passing between a pair of upper and lower discharge rollers 191, and is delivered to the postprocessor 4.

The image forming apparatus 2 has the function of printing on both surfaces of the paper. A pair of paper inverting rollers 182 is mounted on the downstream side of and below the fuser 180, when viewed in a paper conveyance direction. Furthermore, a pair of duplex printing rollers 184 is arranged at a position above the paper feeding section 160 and below the print engine 150. A duplex printing paper conveying path is formed along an array of the pair of paper inverting rollers 182 and the pair of duplex printing rollers 184.

When the paper is subjected to duplex printing in the image forming apparatus 2, the paper conveying path is switched downward short of the pair of discharge rollers 191 after the paper passes through the fuser 180. Therefore, the transfer paper that has been printed on one-side is conveyed in such a manner as to hide under the paper conveying path. The pair of paper inverting rollers 182 reverses, after receiving the paper that has been conveyed downward to convey the paper downward at the beginning, the conveyance direction at the time point where an end on the upstream side of the paper reaches the pair of paper inverting rollers 182. The paper conveyed upward by the inversion is conveyed by the pair of duplex printing rollers 184 after the conveyance direction is switched in such a manner that the paper is curved rightward in FIG. 1 from below the fuser 180. Thereafter, the paper is fed to the registration roller 170 again, and is fed to the print engine 150 in which the timing of printing is synchronized on both surfaces.

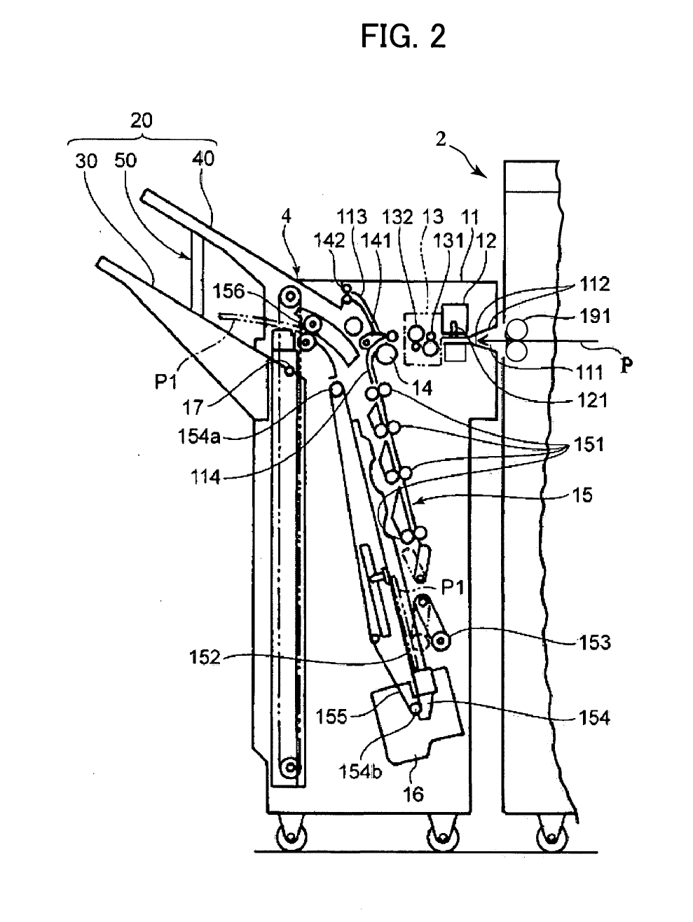

FIG. 2 is a front sectional view for explaining the internal configuration of the postprocessor 4. As shown in FIG. 2, the postprocessor 4 is for punching a hole for filing in a transfer paper sheet P (punch processing) and binding a bundle of temporarily stacked transfer paper sheets P (hereinafter referred to as a paper bundle P1) with a staple (staple processing). The transfer paper sheets P that have been subjected to such punching and stapling are discharged from the postprocessor 4 as paper that has been subjected to post-processing.

The postprocessor 4 includes a housing (a device main body) 11 having a substantially rectangular parallelepiped shape. In this housing 11, a paper carry-in port 111 is formed opposite to the pair of discharge rollers 191 in the image forming apparatus 2. Furthermore, a discharge device 20 that receives the transfer paper sheet P discharged from the postprocessor 4 is provided on a side surface, on the opposite side of the paper carry-in port 111 of the housing 11.

The discharge device 20 has two trays arranged in upper and lower stages. In the present embodiment, the tray positioned on the lower side is a main tray 30, and the tray positioned on the upper side is a sub-tray 40. The paper bundle P1 after the staple processing is discharged to the main tray 30. The staple processing is performed with a discharge mode of the postprocessor 4 set to a staple mode. When the staple mode is set, the postprocessor 4 temporarily stores the paper bundle P1 once at the center of the housing 11, where the paper bundle P1 is subjected to staple processing, and is then discharged to the main tray 30. The transfer paper sheets P discharged one at a time without being subjected to staple processing are discharged to the sub-tray 40. An aligner 50 for aligning the paper bundle P1 on the main tray 30 is mounted between the main tray 30 and the sub-tray 40. Each of the trays 30 and 40 is inclined so as to rise toward the downstream side in the paper discharge direction. Examples of the discharge mode set in the postprocessor 4 include a non-staple mode in which staple processing is not performed, a sorting mode and a non-sorting mode in addition to the abovementioned staple mode.

In any case, the transfer paper sheets P discharged from the pair of discharge rollers 191 in the image forming apparatus 2 are introduced into the postprocessor 4, where the transfer paper sheets P are subjected to punch processing and staple processing, and are then discharged to the main tray 30 or the sub-tray 40 serving as a discharge object. Examples of the transfer paper P include sheet-shaped recording media such as tracing paper and an OHP (Overhead Projector) film, in addition to plain paper.

The paper carry-in port 111 is provided with a pair of upper and lower guide plates 112. The guide plates 112 are arranged in a tapered shape from the upstream side to the downstream side, when viewed in the discharge direction of the transfer paper sheet P. In order to perform the abovementioned punch processing, a punching machine 12 is arranged at a position adjacent to the paper carry-in port 111. The transfer paper sheet P discharged from the pair of discharge rollers 191 is conveyed to the punching machine 12 while being guided by the guide plates 112.

The punching machine 12 includes two punch rods 121 for punching, for example. The punch rods 121 are spaced a predetermined distance (e.g., a distance defined for two-hole stapling) in a direction perpendicular to the discharge direction of the transfer paper sheet P. When the transfer paper sheet P is conveyed, the punching machine 12 temporarily stops the front end of the transfer paper sheet P using a stopper (not shown), and lowers the punch rod 121 with the transfer paper sheet P positioned there, to punch a punching hole at a predetermined position of the transfer paper sheet P. The punch rod 121 penetrates the transfer paper sheet P as it falls, and is inserted into a predetermined punch receiving hole provided in a base further below. A punching scrap receiver 122 is arranged below the punching machine 12, and punching scrap produced by punching (a portion cut by punching) is accommodated in the punching scrap receiver 122. After the transfer paper sheet P is thus subjected to punch processing, the subsequent transfer paper sheet P is then delivered into a curl removing device 13 upon being driven by the pair of discharge rollers 191 when a stopper in the punching machine 12 is retracted.

The curl removing device 13 removes a curl (a habit of bending) that has occurred in the transfer paper sheet P in fixing processing by heating in the image forming apparatus 2. The curl removing device 13 includes two pairs of curl removing rollers 131 and 132. The two pairs of curl removing rollers 131 and 132, respectively, restore the transfer paper sheet P to a flat state by correcting oppositely-directed curls. The direction of the curl differs depending on a state where an image is formed on the transfer paper sheet P (whether the image is copied on one surface or both surfaces of the transfer paper sheet P), for example. When the image forming apparatus 2 has a duplex printing mechanism, however, correction in both the directions is particularly effective.

In the housing 11, a pair of large and small delivery rollers 14 is positioned on the downstream side of the curl removing device 13, when viewed in the paper discharge direction. A first paper conveying path 113 extending obliquely upward toward the sub-tray 40 and a second paper conveying path 114 extending obliquely downward in the opposite direction are further formed on the downstream side of the pair of delivery rollers 14. A position of the pair of delivery rollers 14 is a branch point of the first paper conveying path 113 and the second paper conveying path 114. A branch claw 141 is arranged at the branch point. A destination of conveyance of the transfer paper sheet P is switched to the first paper conveying path 113 or to the second paper conveyance path 114 by the branch claw 141. That is, when the branch claw 141 closes the second paper conveying path 114, the first paper conveying path 113 enters an opened state. The transfer paper sheet P delivered from the pair of delivery rollers 14 in this state is conveyed to a nip of a pair of discharge rollers 142 for a sub-tray upon being guided by the branch claw 141 and the first paper conveying path 113, and is discharged toward the sub-tray 40 upon being driven by the pair of discharge rollers 142 for a sub-tray. On the other hand, when the branch claw 141 closes the first paper conveying path 113, the second paper conveying path 114 enters an opened state. The transfer paper sheet P delivered from the pair of delivery rollers 14 is carried into an intermediate tray 15 upon being guided by the branch claw 141 and the second paper conveying path 114.

The second paper conveying path 114 has four paper carry-in mechanisms 151, which are sequentially arranged therein in series. The paper carry-in mechanisms 151 cause the transfer paper sheet P to be guided onto a paper receiving tray 152 in the intermediate tray 15 through a path that differs depending on the size thereof. The paper receiving tray 152 is capacitively set such that a plurality of transfer paper sheets P (e.g., approximately 20 plain paper sheets) can be held therein. The transfer paper sheet P fed onto the paper receiving tray 152 is fed further downward by a press roller 153, to stand still with the transfer paper sheet P positioned in an acceptor 154. The transfer paper sheet P that has been conveyed through the second paper conveying path 114 is then positioned by the acceptor 154 in such a manner that a transfer surface thereof (in the case of one-side printing) overlaps with a reverse surface of the previous transfer paper sheet P. When the paper bundle P1 is formed with the plurality of transfer paper sheets P aligned on the paper receiving tray 152, the stapler 16 subjects the paper bundle P1 to staple processing.

A drive pulley 154a is mounted in the vicinity of an upper end of the second paper conveying path 114, that is, at the uppermost position of the paper receiving tray 152. On the other hand, a driven pulley 154b is mounted in the vicinity of a lower end of the second paper conveying path 114, i.e., at the lowermost position of the paper receiving tray 152. A continuous belt 155 is stretched between the pulleys 154a and 154b. The acceptor 154 is fixed to the continuous belt 155. When the drive pulley 154a is rotated after the paper bundle P1 is subjected to staple processing, the paper bundle P1 supported on the acceptor 154 is raised upward, and is conveyed to a nip of a pair of discharge rollers 156 for a main tray. The paper bundle P1 is discharged onto the main tray 30 upon being driven by the pair of discharge rollers 156 for a main tray.

The main tray 30 is movable upward and downward along a side surface of the postprocessor 4. In the postprocessor 4, the sensor 17 detects an upper surface position of the main tray 30. The upper surface position of the main tray 30 is so controlled as to be a height position most suited to always load the paper bundle P1. Even when a large number of transfer paper sheets P are discharged onto the main tray 30, a newly discharged paper bundle P1 is discharged without being inhibited by the paper bundle P1, which has already been discharged and loaded onto the main tray 30.

The aligner 50 for lining up respective front ends of the paper bundles P1, which are to be discharged to the main tray 30 with one another, is provided between the main tray 30 and the sub-tray 40. The paper bundles P1, sequentially discharged onto the main tray 30 through the pair of discharge rollers 156 for a main tray upon being driven by the endless belt 155 from the paper receiving tray 152, are subjected to alignment processing by the function of the aligner 50. This prevents a plurality of stacked paper bundles P1 from being misaligned.

As described above, the postprocessor 4 has a post-processing function for subjecting the transfer paper sheet P, on which an image has been transferred, to punch processing and staple processing. In an image forming system, the decision of whether or not punch processing and staple processing should be performed in the postprocessor 4 can be made for each job by a user operating the operating/display section 110 in the image forming apparatus 2, for example. That is, when the user requires the transfer paper sheet P to be perforated for filing in a job which will be subsequently run, the user can perform a predetermined operation (e.g., a button operation or a touch operation) through the operating/display section 110, and select the setting for performing punch processing in the postprocessor 4. Alternatively, when the user requires the transfer paper sheets P to be bundled and stapled in the job which will be subsequently run, the user can perform a predetermined operation (e.g., a button operation or a touch operation) through the operating/display section 110, and select the staple setting for performing staple processing in the postprocessor 4. Furthermore, the user can also select a setting for performing both the punch processing and the staple processing in the job which will be subsequently run. When printing is done on both surfaces of paper, aside from the post-processing such as the punch processing and the staple processing, the user can perform a predetermined operation (e.g., a button operation or a touch operation) through the operating/display section 110, and set duplex printing with respect to a job.

The contents of the settings (set values) made by the user for each job are accepted by the image formation control section 120 in the image forming apparatus 2, and are temporarily stored in the storing section 130. The image formation control section 120 transmits an operation instruction signal to the post-processing control section 250, in addition to controlling driving mechanisms such as the print engine 150, the pair of discharge rollers 191, the pair of paper inverting rollers 182, and the pair of duplex printing rollers 184 on the basis of the setting for each job. The operation instruction signal includes the contents of instructions concerning the punch processing and the staple processing in addition to including information concerning paper size, paper type, number of prints, printing form (one-side printing or duplex printing), etc. for each job. The post-processing control section 250 controls the respective operations of the branch claw 141, the paper carry-in mechanism 151, the drive pulley 154a, the up-and-down operation of the main tray 30, and so on, in addition to controlling the operations of the punching machine 12 and the stapler 16 in accordance with the received instruction signal. This results in the user performing an operation for individually setting the contents of post-processing for each job. Therefore, the postprocessor 4 performs various necessary operations in accordance with the setting.

These are the respective basic configurations and functions of the image forming apparatus 2 and the postprocessor 4. Although the postprocessor 4 is exemplified herein, the postprocessor 4 need not be particularly provided in carrying out the present invention.

In the present embodiment, the image formation control section 120 in the image forming apparatus 2 executes the program as a computer, and correspondingly performs the following operations as the overall image forming apparatus 2.

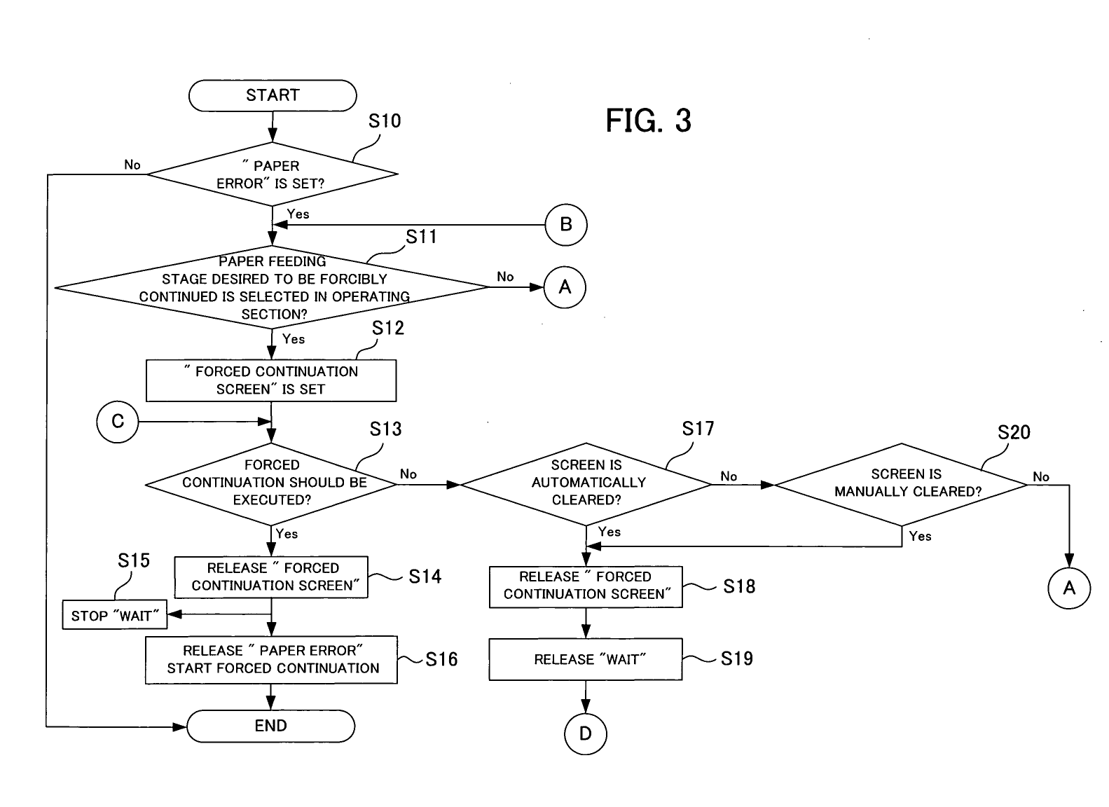

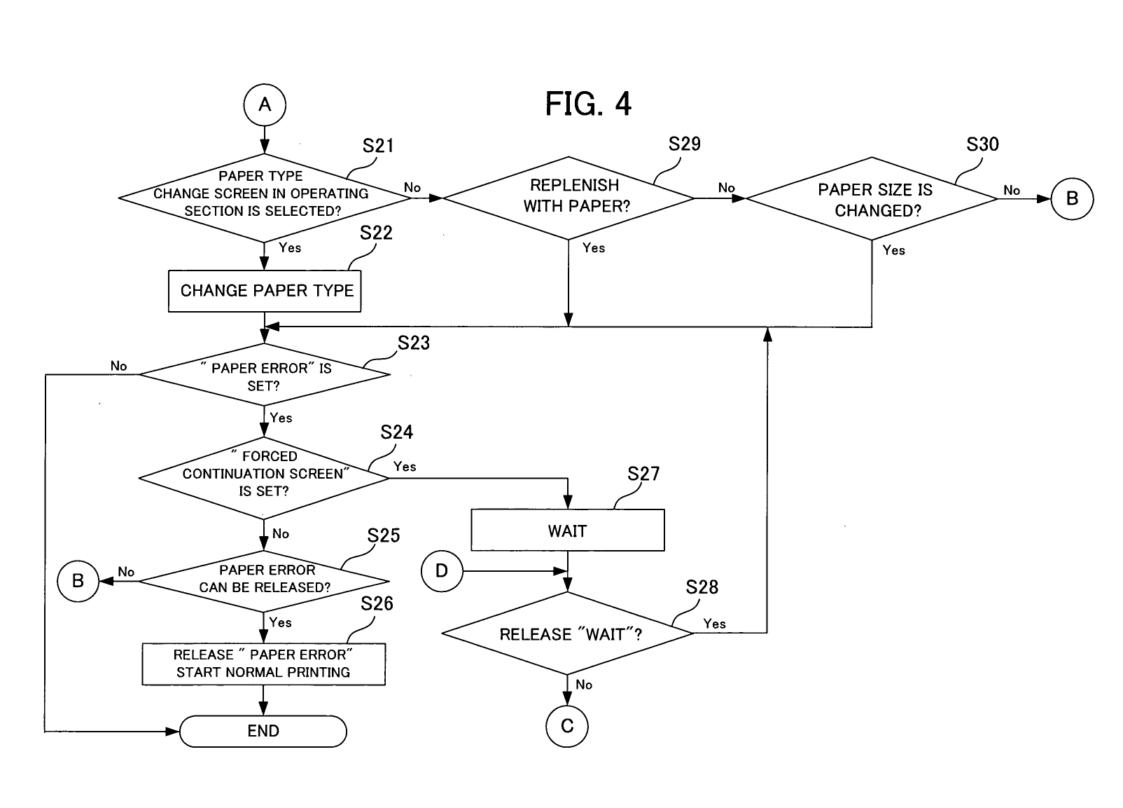

FIGS. 3 and 4 are flow charts showing the procedure for the program executed by the image formation control section 120. The following is a description of the procedure shown in the flow charts.

In step S10, the image formation control section 120 judges whether or not a paper error has occurred with respect to a job that is being executed. Specifically, the image formation control section 120 judges that a paper error has occurred when a paper-out condition and a difference in paper size or paper type occurs with respect to a paper size and a paper type (a media type such as plain paper, a cardboard, and an OHP film) designated in the job by the user. The image formation control section 120 sets “PAPER ERROR” as an internal status when it judges that a paper error has occurred. The internal status is set in the form of a flag in the storage area (RAM) in the storing section 130, for example.

In the present embodiment, the number of paper feeding stages (paper trays) is set to three, for example, in the paper feeding section 160. The size and the type of paper accommodated in each of the paper feeding stages, the direction of the paper, and so on are set in the paper feeding section 160. This information is stored in the storing section 130. Furthermore, the paper feeding section 160 is equipped with a paper-out sensor (not shown) for detecting the presence or absence of paper for each of the paper feeding stages. The paper-out sensor can detect the presence or absence of paper. A detection signal from the paper-out sensor is inputted to the image formation control section 120.

Furthermore, the paper size can be detected by a size detection sensor (not shown) provided in each of the paper feeding stages in the paper feeding section 160. A detection signal from the size detection sensor is also inputted to the image formation control section 120. The image formation control section 120 receives information relating to the presence or absence of paper accommodated in each of the paper feeding stages and the size of the paper on the basis of the signals from the paper-out sensor and the size detection sensor, respectively.

Furthermore, with respect to the paper type (media type), the user can comprehend the information in the image formation control section 120 by inputting the information through the operating/display section 110 for each of the paper feeding stages. It should be noted that the information received in the image formation control section 120 is stored in the storing section 130.

Particularly, if no paper error has occurred (No) in the judgment in step S10, the image formation control section 120 terminates the procedure for the program, and proceeds to another flow chart (not shown) to execute the job.

On the other hand, when it is judged that a printing error has occurred (Yes), the image formation control section 120 carries out the procedure in step S11 and the subsequent steps.

### FIRST EXAMPLE

For example, in a case in which a user desires to print on A4 size paper, one paper feeding stage (e.g., the uppermost stage) is thus designated corresponding to the A4 size paper used in the job. If the job is actually started, but the designated paper feeding stage runs out of A4 size paper, a paper error occurs. At this time, the user may replenish the designated paper feeding stage with A4 size paper. As another way to cope with the paper error, however, the user can have the option of designating another paper feeding stage (e.g., a stage accommodating B4 size paper) to forcibly continue the job. The present embodiment provides the most suitable processing for such a case. The foregoing is specifically described below.

In step S11, the image formation control section 120 judges whether or not the user has selected the paper feeding stage desired for forcibly continuing in the operating/display section 110. In order to prevent FIGS. 3 and 4 from being complicated, the operating/display section 110 is merely referred to as an “operating section” for convenience. Consequently, the judgment is made on the basis of an operation performed by the user for the operating/display section 110.

The operating/display section 110 has a button that the user can operate by pressing, whereby a so-called touch panel display screen is formed. The touch panel causes a button region serving as an image to be displayed on the display screen, and detects, when the user touches the button region, a touch to accept an operation input. Application of the button and the touch panel in the operating/display section 110 are known ones.

In any case, an operation performed by the user through the operating/display section 110 is recognized as an operation signal in the image formation control section 120. As a result, when the image formation control section 120 judges that the user has selected the paper feeding stage (the paper tray 2 in the intermediate stage or the paper tray 3 in the lowermost stage in the foregoing example) desired for forcibly continuing (Yes), it then proceeds to step S12.

In step S12, the image formation control section 120 displays an operation screen for forced continuation in the operating/display section 110, and sets “FORCED CONTINUATION SCREEN” as an internal status (Flag ON).

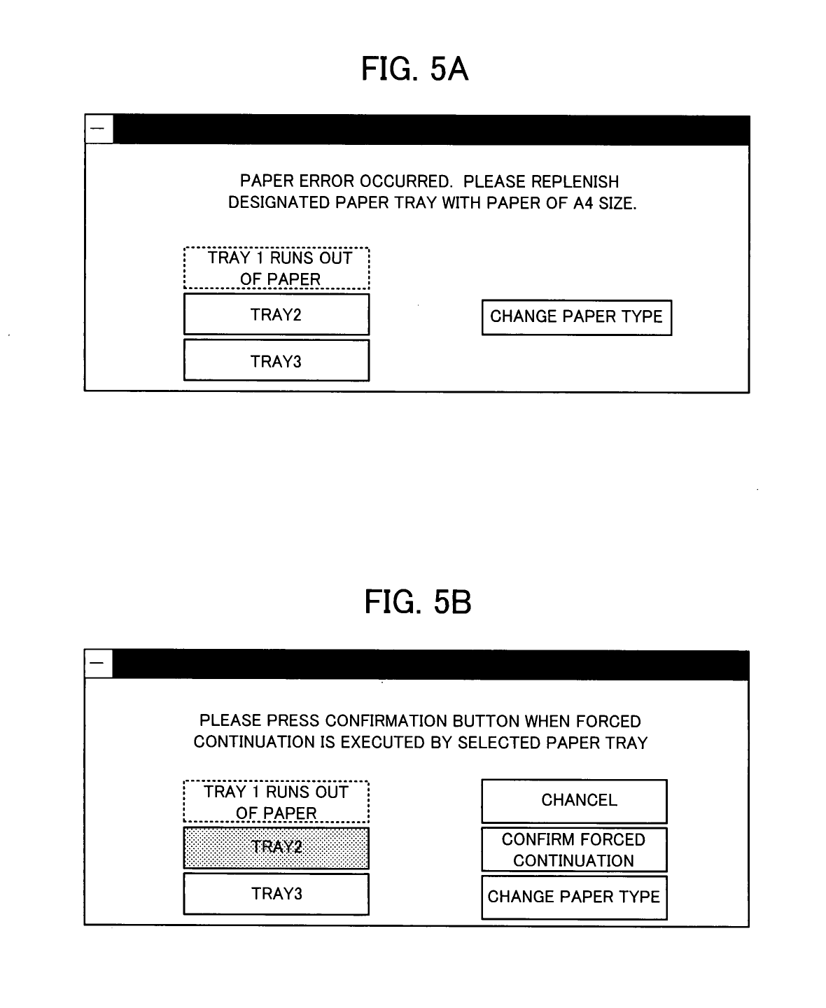

FIG. 5 is a sequential charts showing an example of the operation screen displayed on the operating/display section 110 while a paper error is occurring.

As shown in FIG. 5A, when the paper feeding stage (the paper tray 1) designated using the job, for example, runs out of paper, an error message “Paper error occurred. Please replenish designated paper tray with A4 size paper.” is displayed on the operating/display section 110. Furthermore, a selection button corresponding to the paper tray (the tray 2 or 3 in the first example), which can be selected for forced continuation by the user at this time, is displayed on the operating/display section 110. In addition thereto, an operation button representing “CHANGE PAPER TYPE” is displayed on the operating/display section 110.

At this time, when the user performs a touch operation of another selection button “TRAY 2” or “TRAY 3”, an operation screen (forced continuation screen) shown in FIG. 5B is then displayed on the operating/display section 110. A state where the operation screen is displayed corresponds to “FORCED CONTINUATION SCREEN”, described above. Furthermore, a message “Please press confirmation button to forcibly continue with selected paper tray.”, for example, is displayed on the operating/display section 11. Moreover, an operation button representing “CONFIRM FORCED CONTINUATION” and an operation button representing “CANCEL” are respectively displayed on the operating/display section 110. In addition thereto, an operation button representing “CHANGE PAPER TYPE” is also displayed on the operating/display section 110.

In step S13, the image formation control section 120 judges whether or not forced continuation is to be executed. This judgment can be made depending on whether or not the operation button representing “CONFIRM FORCED CONTINUATION” has been operated.

If the user does not operate the operation button representing “CONFIRM FORCED CONTINUATION” (No) with “FORCED CONTINUATION SCREEN”, described above, the image formation control section 120 then makes judgments in steps S17 and S20.

In step S17, the image formation control section 120 judges whether or not “forced continuation screen” is automatically cleared. This judgment is made by referring to a count value of a timer counter contained in the image formation control section 120, for example. The image formation control section 120 starts, when it sets “FORCED CONTINUATION SCREEN” in step S12, the contained timer counter from the time point, and starts countdown of a timer time period (e.g., approximately 30 seconds) previously set. The program executed by the image formation control section 120 causes “FORCED CONTINUATION SCREEN” to be automatically cleared when the value of the timer counter reaches zero. However, the image formation control section makes the judgment in the step S20 of whether the value of the timer counter has not reached zero yet (No).

In step S20, the image formation control section 120 judges whether or not “FORCED CONTINUATION SCREEN” has been manually cleared. This judgment is made by confirming whether or not the operation button representing “CANCEL” has been operated. Particularly, if the operation button representing “CANCEL” has not been operated (No), the image formation control section 120 proceeds to the subsequent step S21. The procedure in the step S21 and the subsequent steps are shown in FIG. 4 (see a connection symbol A-A in the figure).

In step S21, the image formation control section 120 judges whether or not a paper type change screen has been selected in the operating/display section 110. This judgment is made by confirming whether or not the operation button representing “CHANGE PAPER TYPE” has been operated. The change in paper type herein referred to is made when a paper error occurs from attempting to do printing on cardboard at the beginning, and the user designating the paper feeding stage (the paper tray 1) corresponding thereto using the job, but the paper type in the paper feeding stage being set to plain paper, for example. In this case, when the user performs an operation of replenishing the paper feeding stage (the paper tray 1) first designated to the cardboard, to change the setting of the paper type in the operating/display section 110, the difference in the paper type in the paper feeding stage (the paper tray 1) designated using the job is eliminated. Therefore, the paper error can be eliminated once.

The paper error due to the paper-out condition is assumed in the first example so far described; however, it is considered that the user does not usually operate the operation button representing “CHANGE PAPER TYPE”. Since the operation button representing “CHANGE PAPER TYPE” is not operated (No), the image formation control section 120 then, therefore, makes judgments in the steps S29 and S30. An example of a paper error due to the difference in paper type is described later separately as a second example.

In step S29, the image formation control section 120 judges whether or not the paper feeding stage designated using the job has been replenished with paper. This judgment can be made on the basis of the detection signal from the abovementioned paper-out sensor. When the paper feeding stage (the paper tray 1) designated using the job is replenished with paper in this stage, the paper error in the paper feeding stage can be eliminated once. On the other hand, particularly if the paper feeding stage is not replenished with paper (No), the image formation control section 120 makes the judgment of step S30.

In step S30, the image formation control section 120 judges whether or not the paper size in the paper feeding stage designated using the job has been changed. This judgment can be made on the basis of the detection signal from the abovementioned size detection sensor. The change in paper size herein referred to corresponds to a case where the user replenishes, because in attempting to do printing on paper of A4 size at the beginning, the user is designating the paper feeding stage (the paper tray 1) corresponding thereto using the job, but the paper feeding stage runs out of paper, paper of another size (e.g., B4 size) is fed from the paper stage, for example. In this case, even if the paper size is changed, the paper-out condition in the paper feeding stage (the paper tray 1) designated using the job is eliminated. Therefore, the paper error can be eliminated once.

Particularly, if the paper size is not changed (No) in this stage, however, the image formation control section 120 returns to the previous step S11, to repeat the abovementioned procedure (see a connection symbol B-B in the figure).

On the other hand, when the image formation control section 120 judges that the paper error can be eliminated once (Yes) in the judgment in the foregoing step S29 or S30 (in the other example of the difference in paper type, the steps S21 and S22 are also added), it then proceeds to step S23.

In step S23, the image formation control section 120 confirms again whether or not “PAPER ERROR” has been set. In this stage, “PAPER ERROR” is still set as an internal status (No). Therefore, the image formation control section 120 then proceeds to the step S24.

In step S24, the image formation control section 120 confirms whether or not “FORCED CONTINUATION SCREEN” has been set. In this stage, “FORCED CONTINUATION SCREEN” is set as an internal status (Yes). Therefore, the image formation control section 120 then proceeds to the step S27.

In step S27, the image formation control section 120 sets “Wait” as an internal status. “Wait” herein referred to has the meaning that the image formation control section 120 waits without immediately releasing a paper error state in order to start a printing operation, although an event for eliminating a paper error once (replenishment with paper, change in paper size, etc.) has been confirmed, as described above.

In step S28, the image formation control section 120 judges whether or not “Wait”, described above, has been released. In this stage, “WAIT” has not been released yet (No). Therefore, the image formation control section 120 returns to step S13 as the subsequent procedure (see a connection symbol C-C in the figure).

As described in the foregoing, in the present embodiment, even when the event for eliminating a paper error (replenishment with paper, change in paper size, etc.) with “FORCED CONTINUATION SCREEN” set, the image formation control section 120 sets “WAIT” in step S27, so that a printing operation is not immediately performed.

When the user operates the operation button representing “CONFIRM FORCED CONTINUATION” in the operating/display section 110 while “WAIT” is set, the image formation control section 120 judges that “EXECUTE FORCED CONTINUATION” has been set (Yes) in step S13. In this case, the image formation control section 120 proceeds to step S14 and the subsequent steps.

In step S14, the image formation control section 120 releases “FORCED CONTINUATION SCREEN” serving as an internal status (Flag OFF).

In step S15, the image formation control section 120 then stops “WAIT”. Stop herein referred to means that the fact itself that “WAIT” setting as an internal status is erased.

In step S16, the image formation control section 120 then releases the paper error, and starts the forced continuation. Thus, “PAPER ERROR” serving as an internal status is released (Flag OFF). When the forced continuation is started, the image formation control section 120 terminates the processing shown in the flow charts of FIGS. 3 and 4.

Thereafter, the image formation control section 120 carries out control of the image forming operation performed by the print engine 150, and instructs the paper feeding section 160 to feed paper from the paper feeding stage (the paper tray 2 or 3) selected by the user in “FORCED CONTINUATION SCREEN”. It should be noted that such control is carried out through another processing (not shown).

When the user thus indicates an intention of forced continuation during the paper error, the image formation control section 120 waits, even if the paper feeding stage is replenished with paper and the paper size is changed, for example, in the present embodiment, without starting a printing operation in the stage. When the user's intention of forced continuation is finally confirmed, the user's intention of forced continuation can be assigned priority by feeding paper from the paper feeding stage selected by the user to start a printing operation.

When “WAIT” is indefinitely continued with “FORCED CONTINUATION SCREEN” set, however, reduced reduction in working efficiency as the overall image forming apparatus 2 results. Therefore, the following measures are taken in the present embodiment.

That is, when the user has not operated the operation button representing “CONFIRM FORCED CONTINUATION”, yet in the operating/display section 110 “WAIT” is set, the image formation control section 120 does not judge that “EXECUTE FORCED CONTINUATION” is set (No) in step S13. In this case, the image formation control section 120 makes the judgments in steps S17 and S20 again.

When the image formation control section 120 judges that the forced continuation screen is automatically or manually cleared (Yes) in the judgment in step S17 or S20, it then carries out step S18.

In step S18, the image formation control section 120 clears the operation screen (forced continuation screen) shown in FIG. 5B, and switches the operation screen to the previous screen shown in FIG. 5A. Moreover, the image formation control section 120 releases “FORCED CONTINUATION SCREEN” serving as an internal status (Flag OFF).

In step S19, the image formation control section 120 then releases “WAIT” previously set, in order to proceed to step S28 shown in FIG. 4 (see a connection symbol D-D in the figure).

In this case, the image formation control section 120 makes the judgment in steps S23 again upon receipt of the release of “WAIT” (step S28=Yes). In this step, “PAPER ERROR” is still set (Yes). Therefore, the image formation control section 120 further makes the judgment in step S24.

After the passage of the procedure so far described, the forced continuation screen has already been cleared (No) in the judgment in step S24. Therefore, the image formation control section 120 then makes a judgment in step S25.

In step S25, the image formation control section 120 judges whether or not a paper error is releasable. Specifically, it is judged whether or not an event for eliminating a paper error (replenishment with paper, change in paper size, etc.) has occurred, as previously described. Since “WAIT” has already passed in the foregoing procedure, any event for eliminating the paper error occurs (Yes). Consequently, the image formation control section 120 then proceeds to step S26.

In step S26, the image formation control section 120 releases “PAPER ERROR”, serving as an internal status (Flag OFF), to give an instruction to start normal printing. After the passage of the foregoing procedure, the image formation control section 120 terminates the processing shown in the flow charts of FIGS. 3 and 4.

Thereafter, the image formation control section 120 carries out control of an image forming operation performed by the print engine 150, and instructs the paper feeding section 160 to feed paper from the paper feeding stage (the paper tray 1 in the first example) designated using the job by the user at the beginning. It should be noted that such control is carried out through another processing (not shown).

Even when the user thus indicates an intention of forced continuation during the paper error, the printing operation is started on the basis of an event for eliminating another paper error in the present embodiment in a case where the user's intention of forced continuation is not confirmed within a time period or the user cancels the forced continuation. This prevents a state where the image forming apparatus 2 waits for continuation over a long time period.

### SECOND EXAMPLE

A second example relating to the occurrence of a paper error is next described. In the second example, the redundant descriptions of items basically common to those in the first example are not repeated.

The second example is a case where a paper error occurs because, in attempting to do printing on a cardboard at the beginning, as described above, a user is designating a paper feeding stage (a paper tray 1) corresponding thereto using a job, but the type of paper in the paper feeding stage is set to plain paper. In this case, when the user performs an operation of replenishing the paper feeding stage (the paper tray 1) first designated with cardboard to change the setting of the paper type in the operating/display section 110, the difference in the paper type in the paper feeding stage (paper tray 1) designated using the job is eliminated. Therefore, the paper error can be eliminated once.

In step S22, when an operation of changing the paper type is performed during the paper error (step S21=Yes), the image formation control section 120 changes the paper type in the corresponding paper feeding stage (the paper tray 1). The image formation control section 120 makes the judgments in steps S23 and S24 again.

Here, when the user selects another paper feeding stage (a paper tray 2 or a paper tray 3) at a point in time when the paper error occurs (step S11=Yes), to indicate an intention of forced continuation, the image formation control section 120 judges that “FORCED CONTINUATION SCREEN” is set (step S24=Yes). Therefore, even if an event by which the paper error can be eliminated by changing the paper type also occurs in the second example, the image formation control section 120 sets “WAIT” when the user previously indicates an intention of forced continuation. It should be noted that the subsequent procedure is the same as that previously described in the first example.

The image formation control section 120 can operate the image forming apparatus 2 by assigning priority to the user's intention of forced continuation in the present embodiment by carrying out the foregoing procedure. Therefore, the image forming apparatus 2 can realize a user-friendly mechanical operation without behaving as if the user's intention was ignored.

In the abovementioned first and second examples, in cases where the paper feeding stage is replenished with paper, the paper size is changed, and the paper type is changed before the user operates the operation button representing “CONFIRM FORCED CONTINUATION” are assumed. Particularly when any event does not occur, however, the image formation control section 120 repeatedly makes the judgments in steps S13, S17, and S20.

When the user operates the operation button representing “CONFIRM FORCED CONTINUATION” (step S13=Yes), the image formation control section 120 carries out steps S14 and S16.

On the other hand, if the forced continuation screen is automatically or manually cleared before the user operates the operation button representing “CONFIRM FORCED CONTINUATION”, the image formation control section 120 clears the forced continuation screen in order to return to the previous operation screen, and repeats the judgments in steps S21, S29, and S30 at this time.

### EXAMPLE OF NORMAL ERROR RELEASE

The first and second examples show the procedure in the case where the user indicates the intention of forced continuation during the paper error. On the other hand, particularly when the user does not indicate the intention of forced continuation, normal error release occurs, as described below.

In this case, the user does not perform an operation for selecting a paper feeding stage desired to be forcibly continued in the operating/display section 110 (step S11=No), and the image formation control section 120 makes the judgment in step S21, S29, or S30. When any one of the judgments results in the affirmative (Yes), the image formation control section 120 proceeds to steps S23 and S24.

In the normal error release, a forced continuation screen is not displayed on the operating/display section 110 (step S24=No). Consequently, the image formation control section 120 makes the judgment in step S25. As a result, the image formation control section 120 confirms that an event whereby a paper error can be eliminated has occurred, and proceeds to step S26. In step S26, the paper error is released to start a normal printing operation.

The present invention can be carried out with various modifications without being limited to an embodiment. Although the flow charts shown in FIGS. 3 and 4 are preferred examples, the contents and the order of the steps in the procedure may be changed, as needed.

In addition thereto, various members and driving components in the image forming apparatus and the postprocessor listed in an embodiment are preferable examples, and can be modified, as needed, to carry out the invention.

1. An Image forming apparatus having:
an image forming section that forms an image on the basis of predetermined image data; a transferring section that transfers the image formed by the image forming section onto paper; a plurality of paper accommodating sections that accommodate a plurality of types of paper, respectively, by type; and
a paper feeding section that feeds to the transferring section the designated one of the plurality of types of paper accommodated in the plurality of paper accommodating sections, comprising:
a designating means for designating the type of paper to be fed by the paper feeding section when the image forming section forms the image;
a determining means for determining whether or not the paper is accommodated in the paper accommodating section;
a stopping means for stopping forming of the image by the image forming section when the determining means determines that the type of paper designated by the designating means is not accommodated In the corresponding paper accommodating section;
a continuation instructing means for instructing the image forming section to continue to form the image by feeding the paper from a paper accommodating section different than the paper accommodating section that accommodates the type of paper previously designated with the formation of the image stopped by the stopping means; and
a continuation executing means for continuing, when the continuation instructing means Instructs the image forming section to continue to form the image, to form the image by the image forming section on the basis of the instruction by the continuation instructing means, Irrespective of whether or not the paper accommodating section corresponding to the type of paper designated by the designating means is replenished with the paper.

2. The image forming apparatus according to claim 1, further comprising
a type changing means for changing, with respect to the paper accommodating section corresponding to the type of paper designated by the designating means, the type of paper accommodated therein on the basis of a user's operation with the formation of the image stopped by the stopping means,
wherein the continuation executing means continues to form the image by way of the image forming section on the basis of the instruction by the continuation instructing means, irrespective of whether or not the type changing means has changed the type of paper on the basis of the user's operation.

3. The image forming apparatus according to claim 1, further comprising
a determination means for determining whether or not the continuation executing means is to continue to form the image by the image forming section on the basis of the user's operation,
wherein the continuation executing means suspends the formation of the image stopped by the stopping means, even when the paper accommodating section corresponding to the type of paper designated by the designating means is replenished with paper before the determination means determines that the formation of the image is to be continued, and continues to form the image by way of the image forming section on the basis of the instruction by the continuation instructing means when the determination means determines that the formation of the image should be continued in a state.

4. The image forming apparatus according to claim 3, further comprising
a canceling means for canceling the instruction by the continuation instructing means when a predetermined time period has elapsed in a state where the determination means determines one of the formation of the image should not be continued and the determination means does not determine that the formation of the image is to be continued,
wherein the continuation executing means releases, when the cancelling means cancels the instruction, the suspension of the formation of the image stopped by way of the stopping means without continuing to form the image by the image forming section on the basis of the instruction.

5. The image forming apparatus according to claim 4, further comprising
a resuming means for resuming, when the cancellation of the instruction by the canceling means leads the continuation executing means to release the suspension of the formation of the image stopped by the stopping means without continuing to form the image by the image forming section, the formation of the image by the image forming section when the determining means determines that the paper is accommodated by replenishing the paper accommodating section corresponding to the type of paper designated by the designating means with the paper.

6. The image forming apparatus according to claim 2, further comprising
a determination means for determining whether or not the continuation executing means is to continue to form the image by the image forming section on the basis of the user's operation,
wherein the continuation executing means suspends the formation of the image stopped by the stopping means, even when the paper accommodating section corresponding to the type of paper designated by the designating means is replenished with paper before the determination means determines that the formation of the image is to be continued, and continues to form the image by way of the image forming section on the basis of the instruction by the continuation instructing means when the determination means determines that the formation of the image should be continued in a state.

7. The image forming apparatus according to claim 6, further comprising
a canceling means for canceling the instruction by the continuation instructing means when a predetermined time period has elapsed in a state where the determination means determines one of the formation of the image should not be continued and the determination means does not determine that the formation of the image is to be continued,
wherein the continuation executing means releases, when the canceling means cancels the instruction, the suspension of the formation of the image stopped by way of the stopping means without continuing to form the image by the image forming section on the basis of the instruction.

8. The image forming apparatus according to claim 7, further comprising
a resuming means for resuming, when the cancellation of the instruction by the canceling means leads the continuation executing means to release the suspension of the formation of the image stopped by the stopping means without continuing to form the image by the image forming section, the formation of the image by the image forming section when the determining means determines that the paper is accommodated by replenishing the paper accommodating section corresponding to the type of paper designated by the designating means with the paper.
